(19) United States
(12) Patent Application Publication
(10) Pub. No.: US 2007/0236731 A1
(43) Pub. Date: Oct. 11, 2007

(54) PRINTER DEVICE, SERVER DEVICE AND METHOD FOR PREPARING PRINTED MATTER

(75) Inventor: Yasuto MOCHIZUKI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kanagawa (JP)

(21) Appl. No.: 11/733,040

(22) Filed: Apr. 9, 2007

(30) Foreign Application Priority Data
Apr. 10, 2006 (JP) 2006-107626

(51) Int. Cl. G06F 3/12

(52) U.S. Cl. 358/1.15

(57) ABSTRACT

A printer device can acquire data for printing pertinent to a file recorded on a recording medium and printing so acquired data as necessary. Printer device 10 includes readout unit 20, connection unit 16 connecting the printer device to server device on Internet, and downloading unit. Readout unit 20 reads out a file recorded on recording medium 22. Downloading unit is booted responsive to operation of reading from recording medium 22 to request and download data for printing pertinent to the file recorded on the recording medium 22. Printer device 10 also includes display unit 12 for displaying the kinds of the data for printing downloadable from the server device, and inputting unit 14 for accepting selection of the kinds of the data for printing downloaded from said server device.

### FIELD OF THE INVENTION

This invention relates to a printer device, a server device and a method for the preparation of printed matter. More particularly, this invention relates to a printer device, having the function of communication and of acquiring data for printing as needed, a server device and a method for the preparation of printed matter.

### BACKGROUND OF THE INVENTION

In the JP Patent Kokai Publication No. JP-A-10-16354 and JP Patent Kokai Publication No. JP-P2006-69224A, there is disclosed such a printer having the function of connection to the Internet for downloading data for printing from a site on the Internet and for printing the so downloaded data by the printer itself.

Recently, the business of music distribution for mobile music players is becoming popular, and a jacket or a lyric card, routinely packaged with a CD (Compact Disc), may now be distributed over the internet.

In the JP Patent Kokai Publication No. JP-P2002-99286A, there is disclosed a terminal device having a printing means whereby, in case of downloading music number data on a mobile recording medium, such as memory stick, the contents downloaded may be written on a front surface label of the mobile recording medium. It is stated in the above Patent Document that the terminal device is capable of receiving the title of the music number and the information on the lyric as the printing information, and of printing the so received information on a printing sheet provided within the terminal device.

[Patent Document 1] JP Patent Kokai Publication No. JP-A-10-16354

[Patent Document 2] JP Patent Kokai Publication No. JP-P2006-69224A

[Patent Document 3] JP Patent Kokai Publication No. JP-P2002-99286A

### SUMMARY OF THE DISCLOSURE

The disclosures of the above Patent Documents are incorporated herein by reference thereto. In the course toward the present invention the following analyses have been made by the present invention.

The printer disclosed in Patent Documents 1 and 2 is suited for printing the periodically updated information, such as weather forecast or news. However, in printing the music number related information, the user has to specify an address of a home page or a URL, each time printing is to be made, thus complicating the operation.

With the terminal device of the Patent Document 3, it is unnecessary to specify an address or the URL. However, since the letter/character printing information is also recorded on the mobile recording medium, the recording capacity of the recording medium is taken up by the letter/character printing information, which is less frequently used data, with the result that the number of musical numbers recordable per recording medium is decreased. Thus, there is much to be desired in the art.

In a first aspect, the present invention provides a printer device including a medium interface unit that reads out a file recorded on a recording medium and a network interface unit that connects the printer device to a server device on a network. The printer device includes a means, booted responsive to an operation of reading from the recording medium, to request data for printing pertinent to a file recorded on the recording medium to a server which provides such data for printing, and to download the data.

The printer device may further comprise: display unit that displays kinds of the data for printing downloadable from the server device; and input interface unit that accepts selection of the kind of the data for printing which is to be downloaded from the server device; wherein only the data for printing of the selected kind is requested to the server device.

The information for authentication, written on the recording medium, is transmitted to the server device to request authentication of the right for downloading the data for printing requested.

The printer device may further comprise: means for downloading the file having the preset extension from the preset server device for saving on the recording medium.

In a second aspect, the present invention also provides a server device for providing the printer device with the data for printing or information for authentication for acquiring the data for printing.

Namely, there is provided a server device for selecting and transmitting data for printing relating to a file specified from the printer device.

Also there is provided a server device for transmitting the information for authentication for downloading the data for printing, along with a music number file, to the printer device.

In a third aspect, the present invention provides a method for preparing printed matter using the aforementioned printer device and a server device for selecting and transmitting data for printing relating to the file specified from the printer device. The method includes a step of the printer device specifying the file, as recorded on the recording medium, responsive to the operation of reading from the recording medium, and a step of the printer device requesting data for printing pertinent to the file specified to the server device and downloading the data for printing. In this manner, the data for printing may be printed as necessary, without the necessity of performing a cumbersome operation of inputting the destination for downloading of the data for printing.

In a fourth aspect, the present invention provides a method for preparing printed matter comprising: providing a printer device having a medium interface unit that reads out a file recorded on a recording medium and a network interface unit that connects to Internet, and a server device that selects and transmits data for printing relating to the file specified from the printer device: extracting, with the printer device, a file having a preset extension, as recorded on the recording medium, responsive to an operation of reading from the recording medium; requesting, with the printer device, from the server device data for printing pertinent to the file extracted, to download the data for printing; and printing, with the printer device, the data for printing downloaded.

The method may further comprise: displaying, with the printer device, on a preset display, the kind of data for printing downloadable from the server device; accepting, with the printer device, the selection of the kind of the data for printing from a user; and sending only the data for printing of the kind selected to the printer device.

The method may further comprise: on accepting the request for the printed data requesting, by the server device, the printer device to transmit the information for authentication; transmitting, by the printer device, the information for authentication written on the recording medium; and validating, with the server device, the authenticity of the information for authentication.

The method may further comprise: downloading, by the printer device, a file having a preset extension from a preset server device, and saving the so downloaded file on the recording medium.

The meritorious effects of the present invention are summarized as follows.

According to the present invention, it becomes possible for a printer device itself to acquire data for printing pertinent to a file recorded on a recording medium, in case of necessity, and to print the data for printing, without recording the data for printing on the recording medium itself.

### BRIEF DESCRIPTIONS OF THE DRAWINGS

FIG. 1 is a perspective view showing schematics of a printer in an example of the present invention.

FIG. 2 is a block diagram showing a specified constitution of the printer in an example of the present invention.

FIG. 3 is a flowchart for illustrating the operation of the printer in an example of the present invention.

### PREFERRED MODES OF THE INVENTION

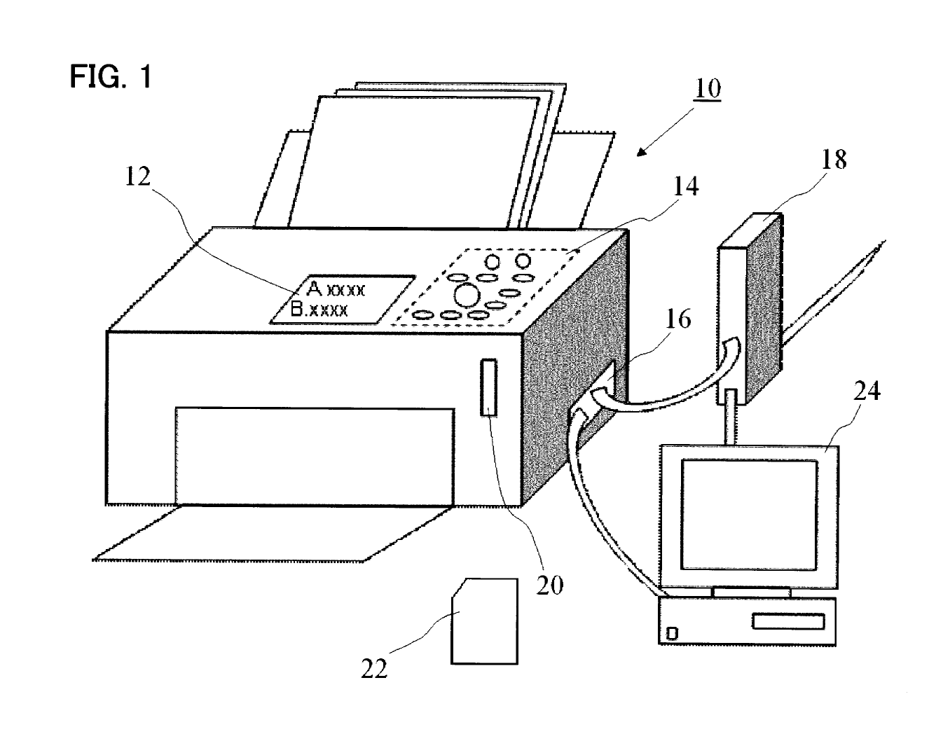

A preferred example of the present invention will now be described with reference to the accompanying drawings. FIG. 1 shows schematics of a printer (printer device) 10 according to an example of the present invention. Referring to FIG. 1, the printer 10 includes a display output unit 12, implemented as a liquid crystal display device, an input interface unit 14, a network interface unit 16 and a medium interface unit (medium readout unit) 20. The input interface unit 14 is made up e.g., of pushbuttons for actuating the printer 10. The network interface unit 16 is used for connecting the printer to a personal computer (PC) 24 or to a networking device 18. The medium interface unit 20 is formed by a slot for receiving and connecting to a recording medium 22, such as a memory card.

Although the printer 10 and the personal computer 24 are shown directly interconnected in FIG. 1, the printer 10 by itself is able to access the Internet over the network interface unit 16, as will be described later. Hence, the personal computer (PC) 24 is not indispensable to the formulation or to the working out of the present invention.

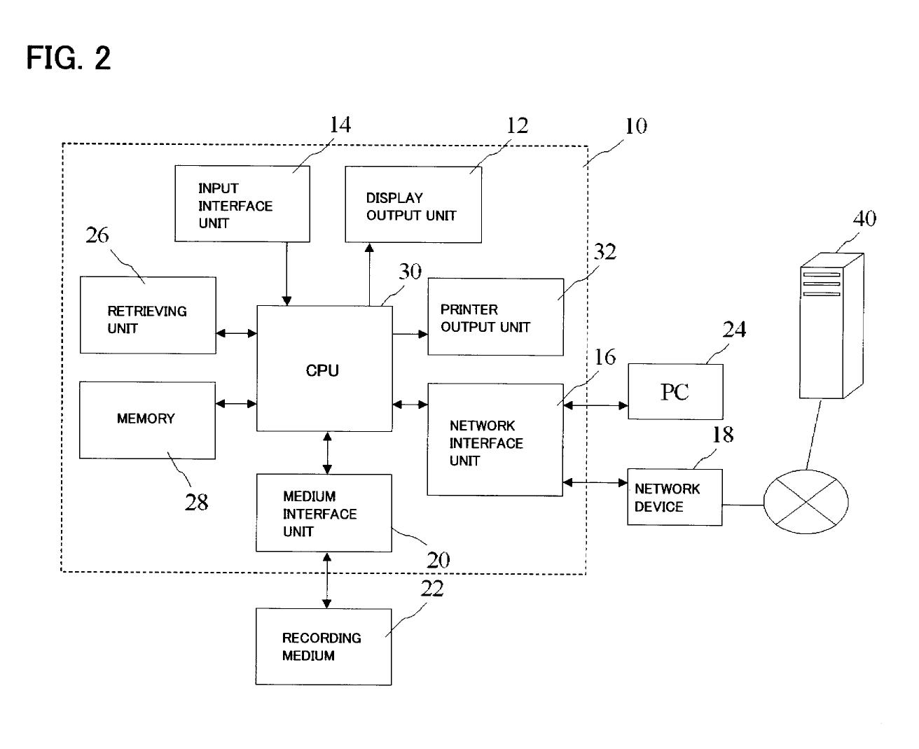

FIG. 2 depicts a specified constitution of the printer 10 of FIG. 1. Referring to FIGS. 1 and 2, the printer 10 includes a retrieving unit 26, a memory 28 and a CPU 30, in its inside, in addition to the display output unit 12, input interface unit 14, network interface unit 16 and the medium interface unit 20, all of which are also shown in FIG. 1. The retrieving unit 26 retrieves data for printing in accordance with contents specified by the input interface unit 14.

The display output unit 12 displays e.g., the information for downloading and the operating states of the printer 10. A user refers to the contents displayed on the display output unit 12 to actuate the printer 10 via the input interface unit 14.

The printer 10 is able to access a sever 40, e.g., a server providing musical number related information on the Internet via the network interface unit 16 and the networking device 18, such as modem.

The musical number related information providing server 40 provides data for printing, such as the title of the musical number, lyric, album, a single jacket or a poster relating to the musical number file.

The operation of the printer 10 of the present example, implemented by the program stored in the memory 28, will now be described in detail.

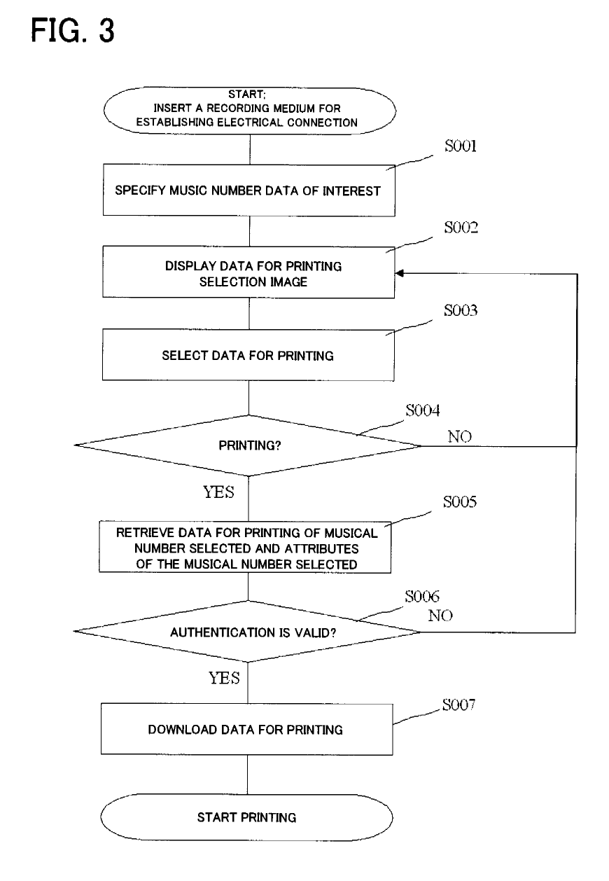

FIG. 3 depicts a flowchart for illustrating the operation of the printer 10 of the present example. With the present printer 10, the function of automatically acquiring data for printing according to the present invention is activated. A sequence of operations is then initiated. These operations include inserting the recording medium 22, having stored therein a music number file, provided with a preset extension, into the medium interface unit 20, by way of electrical connection, in order to acquire the musical number related information relating to the musical number data.

When the recording medium 22 has been inserted into the medium interface unit 20, by way of electrical connection, the printer 10 reads from the recording medium 22, and detects the music number file having a preset extension to display e.g., the title of the musical number on the display output unit 12.

A user actuates an item selection button of the input interface unit 14, as he/she refers to the contents displayed on the display output unit 12, to select a music number for which a printed matter, such as image appendices, including the title, lyric, album/single jacket, poster or the label for a CD-ROM, is to be acquired (step S001).

The printer 10 then displays, on the display output unit 12, a picture image for selection of data for printing. This picture image for selection of data for printing may accept user's selection of kind or kinds of the data for printing, such as image appendices, including the title, lyric, album/single jacket, poster or the label for the CD-ROM (step S002).

The picture image for selection of data for printing may list up a number of alternatives of kinds of data for printing, provided from the outset, without regard to the particular musical number as selected by the user. For example, the picture image for selection of data for printing may display “1. lyric; 2. album; 3. single jacket; and so forth”. Or, an inquiry may be made at the musical number related information providing server 40 as to which be the downloadable data for printing for the musical number of interest. The results of the inquiry may then be used to allow the user to comprehend what are the downloadable data for printing by displaying: “lyric and album are available; single jacket is not available”. The results of the inquiry may also be used to display only the downloadable data for printing by: “1. lyric; 2. album; and so forth”.

The user actuates the item selection button of the input interface unit 14, as he/she refers to the contents displayed on the display output unit 12, to select data for printing which is to be acquired from the musical number related information providing server 40 on the Internet 40 (step S003).

If the user has made a printing command via the input interface unit 14 (YES of step S004), the printer 10 boots the retrieving unit 26 to connect to the musical number related information providing server 40 via the network interface unit 16. The musical number related information providing server then retrieves the data for printing, under the condition as selected in the step S001, that is, the condition concerning the musical number, and under the condition as selected in the step S003, that is, the condition concerning the kinds of data for printing (step S005).

If the musical number related information providing server 40 holds the data for printing as requested by the printer 10, it returns an affirmative response. If the musical number related information providing server 40 is not holding the data for printing as requested by the printer 10, it returns a response to that effect.

On receipt of the affirmative response, the printer 10 requests the musical number related information providing server 40 to authenticate the printer as possessing the right to acquire (download) retrieved data for printing. The musical number related information providing server 40 may also toll the printer at this time. If the authentication has met with success (YES of step S006), the data for printing is downloaded (step S007). The so downloaded data for printing is transmitted to an output unit 32 of the printer to initiate the printing.

If the printing is canceled in the step S004 (NO of the step S004) or if authentication has failed in the step S006, the printer 10 reverts to the step S002 to display the picture image for selection of data for printing. It is noted that authentication is recognized to have failed in case it has not been possible to retrieve the data for printing.

With the present example, described above, the printer 10 accepts selection of data for printing, pertinent to the recorded musical number file, with the connection by insertion of the recording medium 22 as a trigger. The printer 10 may then automatically retrieve and download the data for printing from the Internet. Since data for printing, such as lyric card image or a detailed image for the music number information, used only infrequently, are not recorded on the recording medium 22, it is possible to prevent these data from taking up the recording space of the recording medium 22 to reduce the number of musical numbers recordable on the recording medium.

It is also possible for the printer 10 by itself to download a music number file from a server device, providing musical number files, and to record the so downloaded file on the recording medium 22. This server device may be the musical number related information providing server 40. It is possible in this case to acquire a music number file and data for printing pertinent to the music number in succession.

At the time of the downloading of a music number file, the information on authentication of downloading of the data for printing may be written on the recording medium 22, although this is not stated in the above example. This information on authentication may then be used to authenticate the right to acquire (download) data for printing by the printer 10 from the musical number related information providing server 40. By so doing, a lyric card of a music number file, for example, downloaded by e.g., a mobile phone, may be printed on a PC of the user's premises or on a terminal provided in a shop. It is also possible to have the term of validity or limitations on the number of times of downloading events included in the information for authentication and to have the information for authentication supervised by the musical number related information providing server 40.

Although preferred examples of the present invention have so far been described, it is to be noted that various changes may be attempted without departing from the purport of the invention in which the printing is enabled with the readout of the recording medium 22 in the printer as an incentive. For example, the above example is for a case where the music number file, recorded on the recording medium, is detected, and data for printing, such as title or lyric of the music number, an album, a single jacket or a poster, are received and printed. Alternatively, the music number file may be replaced by other contents files.

It is similarly possible, with the same or similar constitution of the printer 10, to detect a moving picture file or a book file (electronic book file) recorded on a recording medium 22 to receive and print data for printing, such as label image, detailed information on a performer, information on other mediums, e.g., related motion pictures or video, printed images of discount coupons and original images for printing.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A printer device comprising:
medium interface unit that reads out a file recorded on a recording medium, and network interface unit that connects the printer device to a server device on a network;
said printer device comprising:
means for requesting data for printing pertinent to a file recorded on said recording medium including a preset extension from a preset server device and to download said data for printing, said means being booted responsive to an operation of reading from said recording medium.

2. The printer device according to claim 1 further comprising:
display unit that displays kinds of the data for printing downloadable from said server device; and
input interface unit that accepts selection of the kind of said data for printing which is to be downloaded from said server device; wherein
only the data for printing of the selected kind is requested to said server device.

3. The printer device according to claim 1 wherein
information for authentication, written on said recording medium, is transmitted to said server device to request authentication of the right for downloading the data for printing requested.

4. The printer device according to claim 1, further comprising:
means for downloading said file having said preset extension from said preset server device for saving on said recording medium.

5. A server device for selecting and transmitting data for printing relating to a file specified from the printer device according to claim 1.

6. A server device for transmitting the information for authentication for downloading said data for printing, along with a music number file, to the printer device according to claim 1.

7. A method for preparing printed matter comprising:
providing a printer device having a medium interface unit that reads out a file recorded on a recording medium and a network interface unit that connects to Internet, and a server device that selects and transmits data for printing relating to the file specified from said printer device:
extracting, with said printer device, a file having a preset extension, as recorded on said recording medium, responsive to an operation of reading from said recording medium;
requesting, with said printer device, from the server device data for printing pertinent to said file extracted, to download said data for printing; and
printing, with said printer device, said data for printing downloaded.

8. The method for preparing printed matter according to claim 7 further comprising:
displaying, with said printer device, on a preset display, the kind of data for printing downloadable from said server device;
accepting, with said printer device, the selection of the kind of the data for printing from a user; and
sending only the data for printing of the kind selected to said printer device.

9. The method for preparing printed matter according to claim 7 further comprising:
on accepting the request for said printed data requesting, by said server device, said printer device to transmit the information for authentication;
transmitting, by said printer device, the information for authentication written on said recording medium; and
validating, with said server device, the authenticity of said information for authentication.

10. The method for preparing printed matter according to claim 7 further comprising:
downloading, by said printer device, a file having a preset extension from a preset server device, and
saving the so downloaded file on said recording medium.
